(19) United States
(12) Patent Application Publication
(10) Pub. No.: US 2024/0280802 A1
(43) Pub. Date: Aug. 22, 2024

(54) LASER PULSE CASCADE

(71) Applicant: Applied Materials Israel Ltd., Rehovot (IL)

(72) Inventors: Boris GOLBERG, Ashdod (IL); Haim FELDMAN, Nof-Ayalon (IL); Ron NAFTALI, Shoham (IL)

(21) Appl. No.: 18/405,683

(22) Filed: Jan. 5, 2024

Related U.S. Application Data
(60) Provisional application No. 63/447,325, filed on Feb. 21, 2023.

(51) Int. Cl. G02B 26/04

(52) U.S. Cl. CPC G02B 26/04

(57) ABSTRACT

An illumination module of a wafer inspection system including: an illumination source providing ultraviolet illumination with wavelengths below 300 nm; a pulse cascader, optically coupled to the illumination source to receive the ultraviolet illumination, which pulse cascade including a chain of a plurality of loops, each loop including: a loop input and a loop output, a first loop output optically coupled to a loop input of a subsequent loop in the chain; and a delay line having: a delay line input optically coupled to the loop input; and a delay line output, the delay line configured to output a delay line light output, from the delay line output, including an image of light received at the delay line input, after a time delay from a time of receipt of light received at the delay line input; and a splitter configured to receive light at a splitter input and output a first portion of the light from the loop through a loop output and to pass a second portion of the light to the delay line input.

### TECHNOLOGICAL FIELD

The present disclosure, in some embodiments, thereof, relates to illumination of an object for inspection and, more particularly, but not exclusively, to manipulation of laser illumination of semiconductor masks for inspection thereof.

### BACKGROUND ART

Background art, where each art is incorporated by reference into this document in its entirety includes:
U.S. Pat. No. 7,365,836 discloses: “An optical inspection system rapidly evaluates a substrate by illumination of an area of a substrate larger than a diffraction-limited spot using a coherent laser beam by breaking temporal or spatial coherence. Picosecond or femtosecond pulses from a modelocked laser source are split into a plurality of spatially separated beamlets that are temporally and/or frequency dispersed, and then focused onto a plurality of spots on the substrate. Adjacent spots, which can overlap by up to about 60-70 percent, are illuminated at different times, or at different frequencies, and do not produce mutually interfering coherence effects. Bright-field and dark-field detection schemes are used in various combinations in different embodiments of the system.”

Acknowledgement of the above reference/s herein is not to be inferred as meaning that these are in any way relevant to the patentability of the presently disclosed subject matter.

### GENERAL DESCRIPTION

Following is a non-exclusive list of some exemplary embodiments of the disclosure. The present disclosure also includes embodiments which include fewer than all the features in an example and embodiments using features from multiple examples, even if not listed below.
Example 1. An illumination module of a wafer inspection system comprising:
an illumination source providing ultraviolet illumination with wavelengths below 300 nm;
a pulse cascader, optically coupled to said illumination source to receive said ultraviolet illumination, which pulse cascade comprising a chain of a plurality of loops, each loop comprising:
   a loop input and a loop output, a first loop output optically coupled to a loop input of a subsequent loop in said chain; and a delay line having:
      a delay line input optically coupled to said loop input; and
   a delay line output, the delay line configured to output a delay line light output, from said delay line output, comprising an image of light received at said delay line input, after a time delay from a time of receipt of light received at said delay line input; and
a splitter configured to receive light at a splitter input and output a first portion of said light from said loop through a loop output and to pass a second portion of said light to said delay line input.
Example 2. The illumination module according to Example 1, wherein said delay line light output has a same divergence as said light received at said delay line input.
Example 3. The illumination module according to any one of Examples 1-2, wherein said delay line light output has a same beam area as said light received at said delay line input.
Example 4. The illumination module according to any one of Examples 1-3, wherein a magnification of said delay line is one.
Example 5. The illumination module according to Example 1, wherein said delay line includes at least one optical element defining a delay line light path light through said delay line;
wherein said time delay is a time taken for light to traverse said delay line light path through said delay line.
Example 6. The illumination module according to any one of Examples 1-5, wherein said delay line light path comprises conjugate focal planes located at said delay line input and said delay line output.
Example 7. The illumination module according to Example 1-6, wherein said loop output is separated from said loop input by a distance.
Example 8. The illumination module according to any one of Examples 1-7, wherein said splitter and said delay line are configured to orient an optical path of light exiting said loop output in a different direction to said light received by said splitter.
Example 9. The illumination module according to any one of Examples 6-8, wherein splitters and delay lines associated with each loop of said plurality of loops are configured to orient path of light exiting the associated loop in different directions.
Example 10. The illumination module according to any one of Examples 1-9, wherein said delay line comprises a first curved mirror surface and a second curved mirror surface, light traversing an optical path through said delay line being reflected by said first curved mirror surface and then said second curved mirror surface, where said first and said second curved mirror surfaces are positioned and orientated to transfer said image of light received by said delay line input to said delay line output.
Example 11. The illumination module according to Example 10, comprising a third mirror surface where light traversing said optical path is reflected by said third mirror between reflections at said first and said second curved mirror surfaces.
Example 12. The illumination module according to Example 11, wherein said third mirror surface changes a direction of said optical path by at least 90 degrees, folding said optical path.
Example 13. The illumination module according to Example 12, wherein said third mirror surface changes a direction of said optical path by about 180 degrees.
Example 14. The illumination module according to any one of Examples 11-13, wherein said third mirror surface is a planar mirror surface.
Example 15. The illumination module according to any one of Examples 10-14, wherein one or both of said curved mirror surfaces are spherical mirrors.
Example 16. The illumination module according to any one of Examples 10-15, wherein said first and said second curved mirror surfaces are provided by different optical elements.
Example 17. The illumination module according to any one of Examples 10-16, wherein said first and said second curved mirror surfaces are provided by a single optical element.
Example 18. The illumination module according to any one of Examples 1-17, wherein said splitter comprises a partially reflective mirror.
Example 19. The illumination module according to any one of Examples 1-17, wherein said splitter comprises a wedged plate beamsplitter.
Example 20. The illumination module according to any one of Examples 1-17, wherein said splitter comprises a cube beamsplitter.
Example 21. The illumination module according to any one of Examples 1-20, wherein a plurality of splitters each associated with a loop of said plurality of loops comprise at least two of splitters configured to direct light outputted from said cascader to an overlapping region of space.
Example 22. The illumination module according to any one of Examples 1-21, wherein said splitter and said delay line comprise a plurality of optical elements which are held in position by a support structure.
Example 23. The illumination module according to any one of Examples 1-22, comprising a pulsed laser light source optically coupled to said splitter input.
Example 24. The illumination module according to Example 23, wherein a time taken for light to traverse said delay line is longer than a pulse duration of said light source.
Example 25. The illumination module according to any one of Examples 1-24, wherein splitters each associated with a loop of said plurality of loops have different transmissions.
Example 26. An illumination module of a wafer inspection system comprising:
a pulse cascader comprising at least one loop comprising:
   a delay line having a delay line input optically coupled to a loop input and a delay line output, which delay line is configured to output a delay line light output, from said delay line output, comprising an image of light received at said delay line input, after a time delay from a time of receipt of light received at said delay line input; and
a splitter configured to receive light at a splitter input and output a first portion of said light from said loop through a loop output and to pass a second portion of said light to said delay line input.
Example 27. The illumination module according to Example 26, wherein said delay line light output has a same divergence as said light received at said delay line input.
Example 28. The illumination module according to any one of Examples 26-27, wherein said delay line light output has a same beam area as said light received at said delay line input.
Example 29. The illumination module according to any one of Examples 26-28, wherein a magnification of said delay line is one.
Example 30. The illumination module according to Example 26, wherein said delay line includes at least one optical element defining a delay line light path light through said delay line;
   wherein said time delay is a time taken for light to traverse said delay line light path through said delay line.
Example 31. The illumination module according to Example 26, wherein said pulse cascader comprises a chain of a plurality of said loops said loop output optically coupled to a loop input of a subsequent loop in said chain, connection between loops being between delay line output to splitter input.
Example 32. A method of optical inspection comprising:
receiving a laser light pulse having a beam area and a divergence;
splitting said laser light pulse into a first light portion and a second light portion;
outputting said first light portion;
delaying said second light portion which second light portion has a same beam area and divergence as said received laser light pulse; and
repeating said splitting with said second light portion, at least once.
Example 33. The method according to Example 27, wherein delaying comprises changing a direction of said second portion from a direction of said received laser light pulse.

Unless otherwise defined, all technical and/or scientific terms used within this document have meaning as commonly understood by one of ordinary skill in the art/s to which the present disclosure pertains. Methods and/or materials similar or equivalent to those described herein can be used in the practice and/or testing of embodiments of the present disclosure, and exemplary methods and/or materials are described below. Regarding exemplary embodiments described below, the materials, methods, and examples are illustrative and are not intended to be necessarily limiting.

Some embodiments of the present disclosure are embodied as a system, method, or computer program product. For example, some embodiments of the present disclosure may take the form of an entirely hardware embodiment, an entirely software embodiment (including firmware, resident software, micro code, etc.) or an embodiment combining software and hardware aspects that may all generally be referred to herein as a “circuit,” “module” and/or “system.”

Implementation of the method and/or system of some embodiments of the present disclosure can involve performing and/or completing selected tasks manually, automatically, or a combination thereof. According to actual instrumentation and/or equipment of some embodiments of the method and/or system of the present disclosure, several selected tasks could be implemented by hardware, by software or by firmware and/or by a combination thereof, e.g., using an operating system.

For example, hardware for performing selected tasks according to some embodiments of the present disclosure could be implemented as a chip or a circuit. As software, selected tasks according to some embodiments of the present disclosure could be implemented as a plurality of software instructions being executed by a computational device e.g., using any suitable operating system.

In some embodiments, one or more tasks according to some exemplary embodiments of method and/or system as described herein are performed by a data processor, such as a computing platform for executing a plurality of instructions. Optionally, the data processor includes a volatile memory for storing instructions and/or data and/or a non-volatile storage e.g., for storing instructions and/or data. Optionally, a network connection is provided as well. User interface/s e.g., display/s and/or user input device/s are optionally provided.

Some embodiments of the present disclosure may be described below with reference to flowchart illustrations and/or block diagrams. For example illustrating exemplary methods and/or apparatus (systems) and/or and computer program products according to embodiments of the present disclosure. It will be understood that each step of the flowchart illustrations and/or block of the block diagrams, and/or combinations of steps in the flowchart illustrations and/or blocks in the block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart steps and/or block diagram block or blocks.

These computer program instructions may also be stored in a computer readable medium that can direct a computer (e.g., in a memory, local and/or hosted at the cloud), other programmable data processing apparatus, or other devices to function in a particular manner, such that the instructions stored in the computer readable medium can be used to produce an article of manufacture including instructions which implement the function/act specified in the flowchart and/or block diagram block or blocks.

The computer program instructions may also be run by one or more computational device to cause a series of operational steps to be performed e.g., on the computational device, other programmable apparatus and/or other devices to produce a computer implemented process such that the instructions which execute provide processes for implementing the functions/acts specified in the flowchart and/or block diagram block or blocks.

Some of the methods described herein are generally designed only for use by a computer, and may not be feasible and/or practical for performing purely manually, by a human expert. A human expert who wanted to manually perform similar tasks, might be expected to use different methods, e.g., making use of expert knowledge and/or the pattern recognition capabilities of the human brain, potentially more efficient than manually going through the steps of the methods described herein.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a simplified schematic of a system, according to some embodiments of the disclosure;

FIG. 2 is a method of pulse cascading, according to some embodiments of the disclosure;

FIG. 3 is a simplified schematic cross sectional view of a delay line, according to some embodiments of the disclosure;

FIG. 4A is a simplified schematic cross sectional view of a delay line, according to some embodiments of the disclosure;

FIG. 4B is a simplified schematic cross sectional view of a delay line, according to some embodiments of the disclosure;

FIG. 5 is a simplified schematic of a system, according to some embodiments of the disclosure;

FIG. 6A is a simplified schematic of a system, according to some embodiments of the disclosure;

FIG. 6B is a simplified schematic of a system, according to some embodiments of the disclosure;

FIGS. 7A-B are simplified schematics illustrating sequential outputting of light at different positions, according to some embodiments of the disclosure;

FIG. 8 is a plot of simulated output pulse intensity with time, according to some embodiments of the disclosure;

FIG. 9 is a plot of simulated output pulse intensity with time, according to some embodiments of the disclosure;

FIG. 10 is a simplified schematic of a splitter array, according to some embodiments of the disclosure;

FIG. 11A is a simplified schematic of a splitter array, according to some embodiments of the disclosure;

FIG. 11B is a simplified schematic cross sectional view of a splitter array, according to some embodiments of the disclosure; and

FIGS. 12A-B are simplified schematic cross sectional views of a pulse cascader, according to some embodiments of the disclosure.

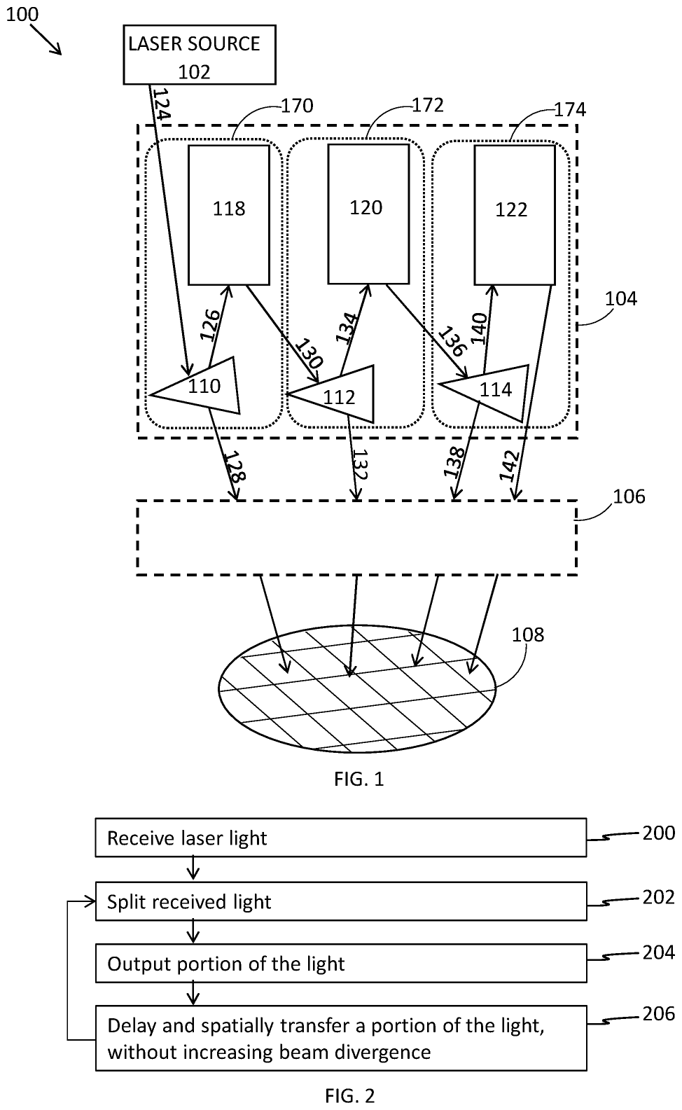

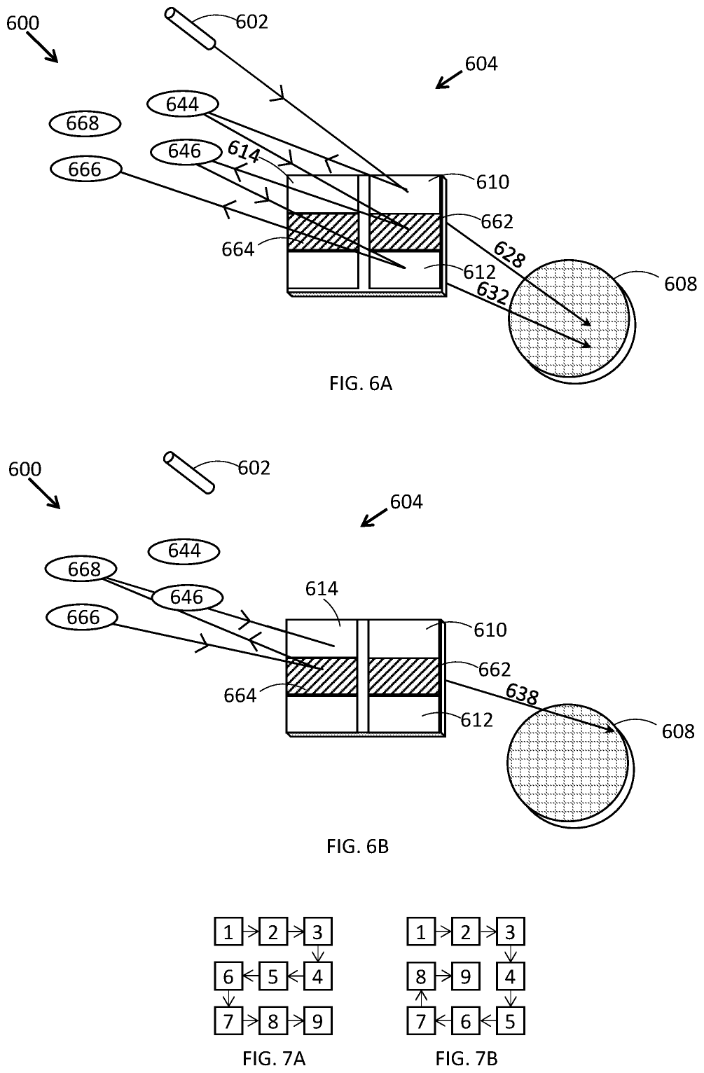

In some embodiments, although non-limiting, in different figures, like numerals are used to refer to like elements, for example, element 102 in FIG. 1 corresponding to element 602 in FIG. 6.

### DETAILED DESCRIPTION OF EMBODIMENTS

The present disclosure, in some embodiments, thereof, relates to illumination of an object for inspection and, more particularly, but not exclusively, to manipulation of laser illumination of semiconductor masks for inspection thereof.

### Overview

A broad aspect of some embodiments of the disclosure relates to inspection of an object using a single illumination pulse (e.g. comprising partially coherent light) from a light source where an area of the object illuminated is increased and/or a duration of illumination of (at least a portion) of the object is increased above that provided by the initial pulse, without expanding (or without significantly expanding) the light beam (e.g. a cross section of the light beam).

An aspect of some embodiments of the disclosure relates to splitting an initial light pulse into a plurality of portions and outputting the pulse portions each at a different time, for example, as performed by an optical module of an optical inspection system. Optionally, in some embodiments, one or more of the outputted light pulse portions are outputted from a different region of space and/or in a different direction (e.g. to be eventually incident of a different portion of a target). In some embodiments, a time delay between outputted pulse portions is longer than a duration of the initial laser pulse.

A potential advantage of temporal (and optionally spatial) differences in outputted pulse portions, for example, in a system including diffuser/s, is reduction of speckle contrast associated with the illuminating light.

In some embodiments, splitting of the light, reduces a magnitude of outputted light pulses (e.g. in comparison to the initially received light pulse). A potential benefit being the ability to use a higher intensity initial pulse without damaging the target object to be inspected.

An aspect of some embodiments of the disclosure relates to cascaded splitting of an incident laser light pulse at a plurality of loops. Where, in some embodiments, each loop includes a splitter, where, at one or more of the splitters, a first portion of the incident laser pulse is outputted and a second portion of the incident laser pulse is transferred to a successive loop. Where, in some embodiments, each loop includes a delay line which delays light by a delay time (e.g. associated with an optical path length of the delay line) e.g. to output pulse portions at different times. Optionally, in some embodiment, one or more of the loops also transfers light spatially, where light is outputted at a different position and/or in a different direction to light received by the loop. In some embodiments, the spatial change/s producing a train of pulse portions in time where one or more of the pulse portions illuminates a different portion of a region of space e.g. of condenser optics through which an object to be inspected is illuminated.

In some embodiments, a proportion of light received and outputted by splitters increases with successive loops, for example, to reduce and/or prevent reduction in intensity of outputted pulses from successive loops. For example, in an exemplary embodiment, proportion of light outputted by splitters is selected to generate output pulses of equal intensity.

For example, where, in some embodiments, transmission of the beam splitters is calculated using equation 1:

$${τ}_{k} = \frac{1}{n - k} ; k = 0 , 1 , 2 , … , n - 1 \qquad Equation 1$$

Where τₖ is transmission for the k^{th} beam splitter and n is a total number of splitters.

In some embodiments, one or more of the loops includes a delay line having an optical path which delays light without increasing divergence of the light. For example, in some embodiments, the delay line includes at least two mirror surfaces where a light path from an input to the delay line, impinging on both mirror surfaces and exiting the delay line is delayed by travel time (also herein termed “loop delay”). Where, in some embodiments, one or more of curvature, focal distance, positioning, and orientation of the mirror surfaces are selected to produce an image of light received at the delay line input at the delay line output. In some embodiments, the delay line acting to image a laser output window forming the input to the cascader. For example, the input of the delay line and the output of the delay line being conjugated planes. In some embodiments, magnification of the delay line is unity meaning, for example, a beam area of the outputted light is the same as the beam area of that received by the delay line.

In some embodiments, a distance travelled by light on the optical path between the two mirror surfaces of the delay line is F1+F2 where F1 is the focal distance of the first mirror surface and where F2 is the focal distance of the second mirror surface. Where, in some embodiments, a distance travelled by light on the optical path between an input and an output to the delay line is 2(F1+F2).

In an exemplary embodiment, both mirror surfaces have a same focal distance.

In some embodiments, after traversing the delay line of a loop, the light path extends to an input of a successive loop where it is split, a portion outputted and a portion delayed (e.g. by an additional delay line), for example, before being transferred to a successive loop of the plurality of loops of the pulse cascader.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

### Exemplary System

FIG. 1 is a simplified schematic of a system 100, according to some embodiments of the disclosure.

In some embodiments, system 100 includes a laser source 102. Where laser source 102 is used to illuminate a target 108, for inspection of target 108. Where, in some embodiments, target 108 includes a mask (e.g. for semiconductor device lithography). Where, in some embodiments, target 108 includes a semiconductor wafer (e.g. pre-processing and/or during and/or after processing and/or patterning procedures).

In some embodiments, system 100 includes a pulse cascader 104 (also herein termed “illumination module” of optical inspection system 100) which, upon receiving an input light pulse 124 divides the light pulse into a plurality of portions which are then outputted at different times and at different positions e.g. as delineated in the method of FIG. 2.

In some embodiments, pulse cascader 104 includes one or more beam splitters 110, 112, 114.

In some embodiments, a first beam splitter 110 (and optionally one or more additional beam splitter 112, 114) splits received light 124 (e.g. received from laser source 102) into a first portion 126 and second portion 128, where the first portion 126 is outputted from cascader 104. First portion 126 optionally passing through one or more additional optical elements 106 before being incident on target 108.

Where, in some embodiments, optical element/s 106 include one or both of shaping optics and condenser optics which configure the light for illumination of target 108.

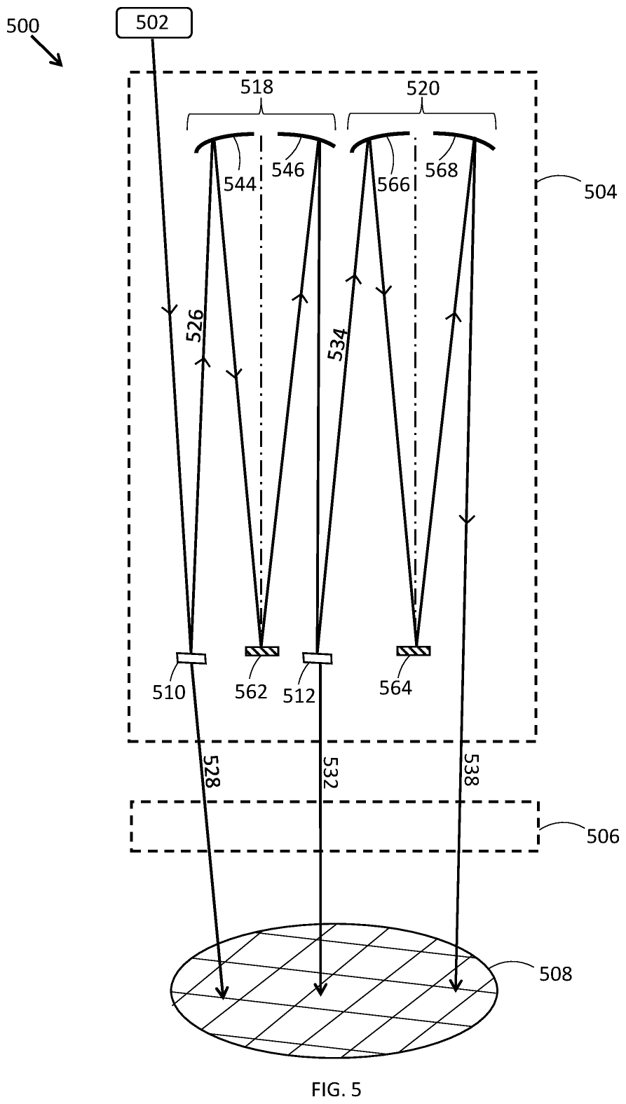

Although light is illustrated in FIG. 1 (and FIG. 5) as being directed to a target, in this for simplicity of understanding and it should be understood that optical element/s 106, in some embodiments, include complex module/s which configure the pulses as described in this disclosure for use in inspection of a target.

In some embodiments, second portion 128 is received by a delay line 118 which spatially moves as well as temporally delaying received light: Light 130 being both emitted at a later time and at a different position to light received 126.

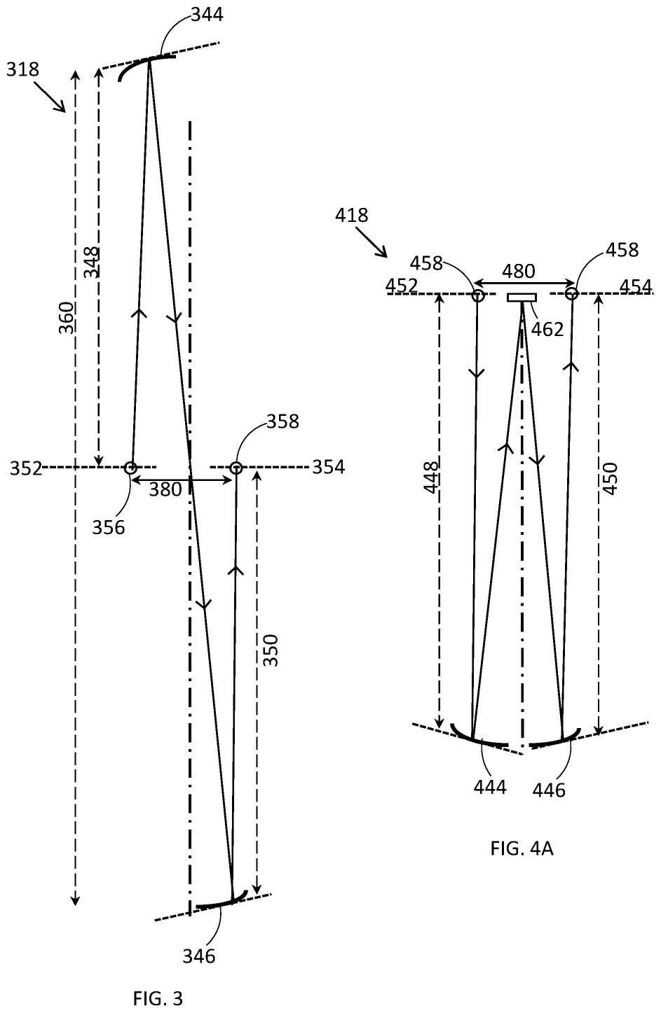

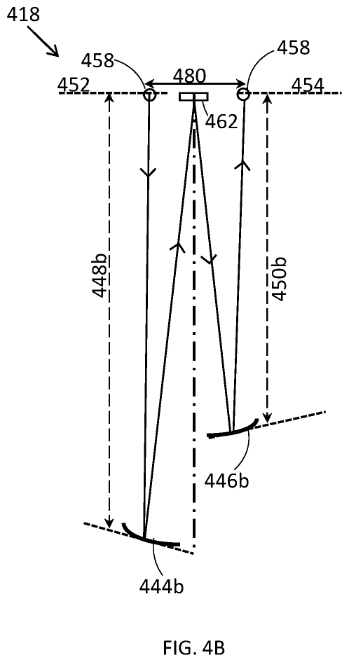

In some embodiments, delay line 118 does not increase beam divergence of the received light. Delay line 118, for example, including one or more feature as illustrated in and/or described regarding FIG. 3 and/or FIG. 4A and/or FIG. 4B.

In some embodiments, additional splitter/s 112, 114 and additional delay lines 120, 122 are used to produce additional light outputs where each light output 132, 138, 142 is at a different time and a different position.

In some embodiments, an array of splitter-delay line pairs is used to provide an array of light outputs, for example, to provide a plurality of pulses from a single input pulse e.g. to illuminate different portions of an area of target 108 and/or to sequentially illuminate target 108 with a plurality of temporally separated pulses.

In some embodiments, one or more of splitters 110, 112, 114 includes a partially reflective mirror.

In some embodiments, one or more of splitters 110, 112, 114 includes a wedged plate beamsplitter. Where, in some embodiments, angles of planes of the wedged plate beamsplitter and/or orientation of the wedged plate beamsplitter are selected to direct outputted light at a desired position and/or direction.

In some embodiments, one or more of splitters 110, 112, 114 includes a cube beamsplitter.

In some embodiments, one or more optical element (e.g. each optical element) e.g. splitter/s 110, 112, 114, and/or optical element/s of delay line/s 118, 120, 120, include coatings to minimize losses of light associated with interaction of the light with the elements (e.g. via absorption).

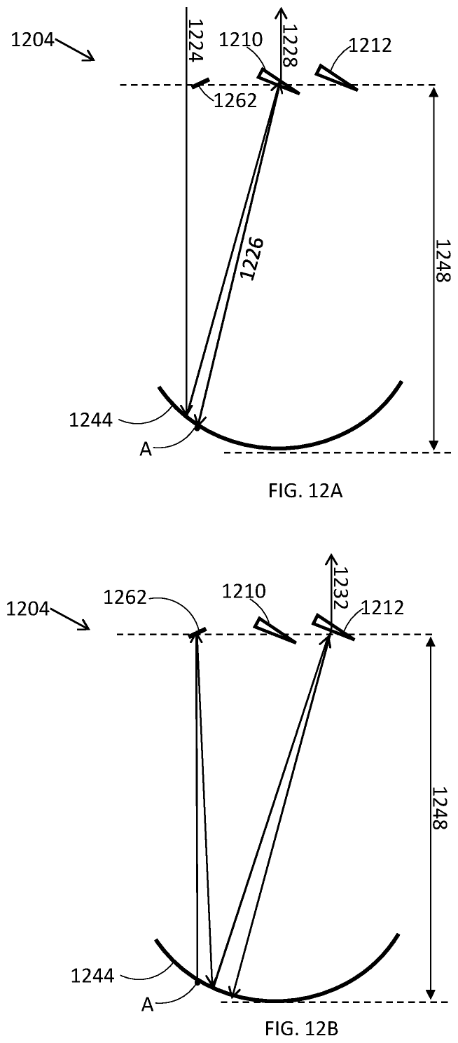

In some embodiments, one or more optical element forms parts of more than one delay line 110, 112, 114. For example, as illustrated in FIGS. 12A-B, in some embodiments, a single mirror provides portions for more than one delay line.

### Exemplary Method

FIG. 2 is a method of pulse cascading, according to some embodiments of the disclosure.

At 200, in some embodiments, a laser light beam is received.

In some embodiments, the laser light beam includes ultraviolet light. In some embodiments, the light including wavelength/s of 100-400 nm, or 150-250 nm, or including wavelengths of about 193 nm, or lower or higher or intermediate wavelengths or ranges.

In some embodiments, the laser light beam has intensity or 200-600 mW, or 300-500 mW, or about 400 mW, or lower or higher or intermediate intensities or ranges.

In an exemplary embodiment, the laser light beam includes wavelengths of about 193 nm and has an intensity of 400 mW.

In some embodiments, a pulse of laser light is received.

In some embodiments, the light is partially coherent.

In some embodiments, the laser light is focusable to an area of 20 times the diffraction limit as defined by wavelength/s of the laser light emitted.

In some embodiments, the light has a cross sectional area of 1-40 mm², or 10-30 mm², or 15-25 mm², or about 18 mm², or lower or higher or intermediate ranges or areas.

In some embodiments, the light cross sectional shape is rectangular, for example, in an exemplary embodiment, having a cross section of about 6×3 mm.

In some embodiments, the light has divergence of 0.1-2 mRad, 0.5-1.5 mRad, or about 1 mRad.

In some embodiments, the light has a beam propagation ratio (M²) of 15-25, or about 20.

In some embodiments, for example, the beam has a cross section of about 6×3 mm.

In some embodiments, divergence of the light is different for different directions. For example, in some embodiments, the beam is rectangular in cross sectional shape, in a direction of a long axis of the rectangle, the divergence is larger than (e.g. 1.5-5 times, or about double) in a direction of a cross axis of the rectangle. In an exemplary embodiment, divergence in the long axis is 1-3mR, or about 2mR (or lower or higher or intermediate ranges or divergences) and the cross axis is 0.5-2mR (or lower or higher or intermediate ranges or divergences) 1mR.

In an exemplary embodiment, a beam area of the received light is about 6×3 mm, the light having an about 1 mRad divergence and a beam propagation ratio (M²) of about 20. In some embodiments, divergence of the received light is 1×2mR.

At 202, in some embodiments, the received light pulse is split into at least two portions.

Where, at 204, in some embodiments, a first portion of the light is outputted (e.g. to be incident on a target for inspection of the target).

Where, at 206, in some embodiments, a second portion of the light is delayed and/or spatially transferred, without increasing the beam divergence of the laser light pulse.

In some embodiments, the second portion is then re-split at step 202, steps 202-206 being repeated, to output a train of laser pulses 128, 132, 138, 142 (FIG. 1), each pulse at a different time and spatial location e.g. to arrive at a different portion of the target.

### Exemplary Delay Lines

FIG. 3 is a simplified schematic cross sectional view of a delay line 318, according to some embodiments of the disclosure.

In some embodiments, delay line 318 includes at least a first curved mirror 344 and a second curved mirror 346, an input 356, and an output 358. Where light received at input 356 passes to first curved mirror 344 which reflects the light to second curved mirror 346 which reflects and focuses the light to output 358. Where, in some embodiments, a path of light through delay line 318 is illustrated by solid lines having central arrow-heads which show direction of light along the path.

In some embodiments, mirror characteristics including one or more of orientation, focal length, and distance between each other are selected to position conjugated planes 352, 354 at input 356 and output 354. Where focal lengths are illustrated in FIG. 3: first mirror focal length 348 and second mirror focal length 350. So that light received at input 356 is outputted at output 358 with a same beam divergence.

In some embodiments, mirror characteristics are selected to position input 356 and output 358 at a desired separation e.g. by distance 380.

In some embodiments, focal lengths 348, 350 are selected to provide a desired temporal delay between receipt of light at input 356 and exit of the light at output 358.

FIG. 4A is a simplified schematic cross sectional view of a delay line 418, according to some embodiments of the disclosure.

In some embodiments, delay line 418 includes at least a first curved mirror 444 and a second curved mirror 446, an input 456, and an output 458. Where light received at input 456 passes to first curved mirror 444 which reflects the light to second curved mirror 446 which reflects the light to output 458. Where, in some embodiments, a path of light through delay line 418 is illustrated by solid lines having central arrow-heads which show direction of light along the path.

Referring now back to FIG. 3, input 356 and output 358 are both located centrally to delay line (at least in the plane illustrated).

Referring now to FIG. 4A, in some embodiments, delay line 418 includes optical element/s e.g. a folding mirror 462 (also herein termed “third mirror”) which “folds” the delay line optical path, for example, positioning both mirrors on a same side of delay line 418 and/or both input 452 and output 458 on a same side of delay line 418. In some embodiments, folding mirror 462 changes an optical path of the delay line by at least 5 degrees, or by 45-180 degrees, or 160-180 degrees, or about 180 degrees (e.g. as illustrated in FIG. 4A). A potential benefit of folding of the delay line optical path being compactness of delay line 418.

In some embodiments, mirror characteristics including one or more of mirror curvature, orientation, focal length (if the mirror is curved), and distance between each other are selected to position conjugated planes 452, 454 at input 456 and output 454. Where focal lengths are illustrated in FIG. 4A: first mirror focal length 448 and second mirror focal length 450. So that light received at input 456 is outputted at output 458 with a same beam divergence.

In some embodiments, a system (e.g. system 100 FIG. 1, e.g. system 500 FIG. 5) includes a total beam travel distance (e.g. from entry of the initial pulse to outputting of a final pulse portion) is about 100 m. Where, in some embodiments, each the system includes 10 loops each about 10 m long. Where beam divergence of the beam into the system being 1 mRad and having a width 0.5 cm without refocusing, after travel of 100 m beam width is 10 cm.

In some embodiments, mirror characteristics are selected to position input 456 and output 458 at a desired separation e.g. by distance 480.

In some embodiments, focal lengths 448, 450 are selected to provide a desired temporal delay between receipt of light at input 456 and exit of the light at output 458.

In an exemplary embodiment, one or both of mirrors 446, 444 are spherical mirrors. In an exemplary embodiment, mirror 462 is a planar mirror.

In some embodiments, focal distances 448, 450 are the same. Where, in an exemplary embodiment, focal distances 448, 450 are each 2 m corresponding to of a delay time of (2×4)/(3×10⁸)=26.6 nSec. In an exemplary embodiment, reflectance R of each of mirrors 444, 446, 462 is 98.3%. In some embodiments, reflectance R of each of the mirrors is sufficiently high so that a sum of power of the multiple pulses emitted is at least 95%, or 90%, or 80%, of a power of the initial light pulse.

In an exemplary embodiment, a radius of curvature, R of one or both of curved mirrors 444, 446 is 10 cm-10 m, or 2-5 m, or about 4 m, or lower or higher or intermediate radii of curvature or ranges. In an exemplary embodiment both of mirrors 444, 446 have curvature of 4 m±10%.

In some embodiments, delay line 408 includes an optical element with which light traversing an optical path through the delay line interacts more than once. For example, mirrors 444, 446, in some embodiments, are replaced by a single mirror e.g. including one or more feature as illustrated in and/or described regarding FIGS. 12A-B. A potential benefit being reduced numbers of optical elements e.g. contributing to reduced cost and/or complexity of construction of the device e.g. construction including positioning and/or calibration of optical elements.

FIG. 4B is a simplified schematic cross sectional view of a delay line 418b, according to some embodiments of the disclosure.

In some embodiments, delay line 418b of FIG. 4B includes one or more feature as illustrated in and/or described regarding delay line 418 FIG. 4A. where, in some embodiments, like numerals indicate like elements.

In some embodiments, for example, as illustrated in FIG. 4B, a first curved mirror 444b and a second curved mirror 446b which, in some embodiments, direct light as described regarding first and second curved mirrors 444, 446 FIG. 4A, have different focal lengths 448b, 450b.

In some embodiments, mirror 462 (for one or both of the embodiments illustrated in FIG. 4A and FIG. 4B) is curved e.g. contributing to focusing of light between points 452 and 454.

### Exemplary Systems

FIG. 5 is a simplified schematic of a system 500, according to some embodiments of the disclosure.

In some embodiments, system includes a laser light source 502, a cascader 504, optional optical element/s 506. Where one or more of light source 502, cascader 504, and optional optical element/s 506 (when present) include one or more feature as described and/or illustrated regarding light source 102, cascader 104, optional optical element/s 106 FIG. 1. Where, in some embodiments, system 500 directs light to a target 508 to be inspected (target 508 e.g. including one or more feature as described regarding target 108, FIG. 1).

In some embodiment, cascader 504 includes two loops, each loop including a delay line 518, 520 and a splitter 510, 512. Where delay lines 518, 520, in some embodiments, each include one or more feature of delay line 418 FIG. 4A and/or FIG. 4B. For example, where each delay line 518, 520 includes a first curved mirror 544, 566, a second curved mirror 546, 568, and a folding mirror 562, 564, respectively.

In some embodiments, cascader 504 includes more than two loops. For example, 3-100, or 3-50, or 10-30, or 10-20, or lower, or higher, or intermediate ranges, or numbers of loops.

In some embodiments, a number of loops used depends on absorption of light by each loop. For example, in an exemplary embodiment, where absorption is 1-2% at each loop, 10-20 loops are employed.

In some embodiments, FIG. 5 illustrates across sectional view of cascader, where distance between outputs from the cascader is in a plane of the figure. In some embodiments, cascader 504 includes additional delay line/s not illustrated in FIG. 5 which are spatially positioned at a distance away from delay lines illustrated in a direction perpendicular to a plane of the figure. Where, for example, instead of outputting pulses in a linear arrangement onto target 508 (e.g. as illustrated), an array of pulses are outputted, pulses also illuminating region/s of target 508 away from the line described by pulses 528, 532, 538 on target 508.

Although FIG. 5 illustrates a delay line 518 having 2 curved mirrors and one flat mirror, other possible arrangements of optical elements (e.g. one or more lens, and/or diffractive elements) which produce conjugated planes at 510 and 562 as understood by a person skilled in the art of optics are envisioned and encompassed.

FIG. 6A is a simplified schematic of a system 600, according to some embodiments of the disclosure.

FIG. 6B is a simplified schematic of a system 600, according to some embodiments of the disclosure.

In some embodiments, FIG. 6A and FIG. 6B illustrate different portions of an optical path through a same system 600.

Where, in some embodiments, system 600 includes a laser light source 602 and a pulse cascader 604 which includes at least one loop and, optionally, in some embodiments, a plurality of loops.

Where, in some embodiments, each loop includes a splitter and a delay line. Where one or more delay line includes, for example, first, second, and third mirrors.

For example, a first loop includes a first splitter 610, and a first delay line which includes mirrors 644, 662, 646. For example, a second loop including a second splitter 612, and a second delay line which includes mirrors 666, 664, 668.

In some embodiments, FIG. 6A and/or FIG. 6B illustrate an exemplary technique where 3D positioning of optical elements is used to output light 628, 632, 638 to different portions of a target 608 (e.g. without requiring movement of system 600 and/or target 608).

FIGS. 7A-B are simplified schematics illustrating sequential outputting of light at different positions, according to some embodiments of the disclosure.

In some embodiments, FIGS. 7A-B illustrate exemplary sequences in time of outputted light from a cascader e.g. the figures illustrating a cross section of the outputted light where the cross section is taken in a direction generally perpendicular to a direction of output of light. Where, in some embodiments, numerals in the figures illustrate a temporal order of outputting of light and/or where arrows illustrate spatial transfer of light between outputs (e.g. by delay line/s).

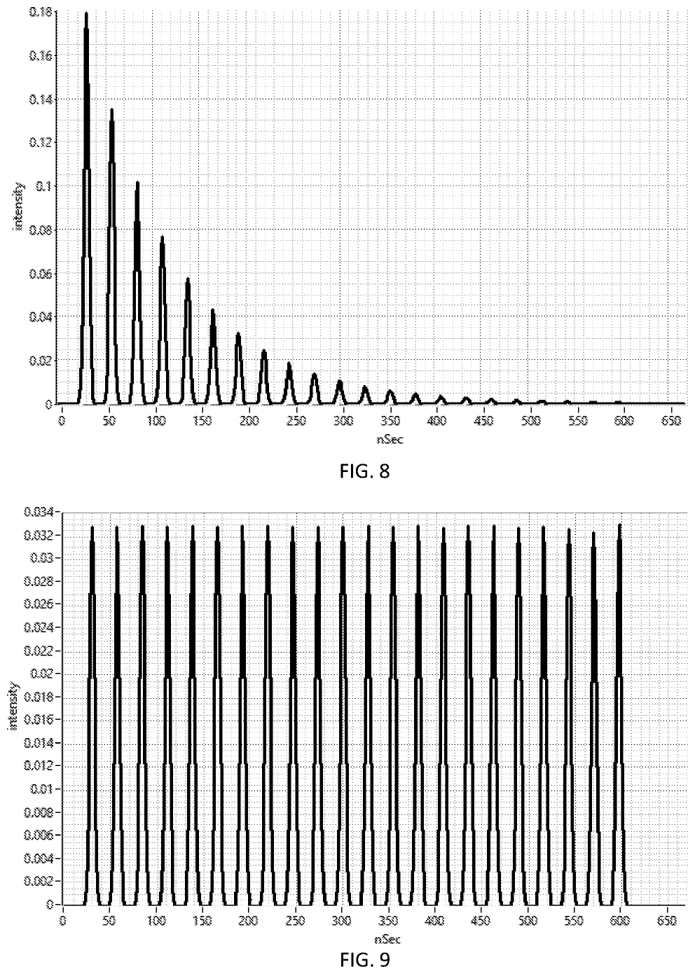

FIG. 8 is a plot of simulated output pulse intensity with time, according to some embodiments of the disclosure.

Where, in some embodiments, FIG. 8 illustrates outputted light intensity (in arbitrary units) with time, for a system with a plurality of loops where each splitter of each loop outputs a same portion of received light, the intensity of outputted light sequentially reducing (e.g. having an exponentially reducing magnitude) for each pulse.

Where, exemplary parameters inputted to produce simulation results include: A cascader including 22 loops, each loop having a splitter and three mirrors. Where the input pulse has a FWHM (full width half medium) of 7 nSec, a loop delay is 26.6 nSec, each mirror of each loop has a reflectance R of 98%. Splitters of each loop have a transmittance T of 20% and absorbance (Abs) of 1%, the cascader total throughput being 72%.

Where the loop delay, in some embodiments, is associated with time taken for light to pass between the two curved mirrors, each with a focal distance of 2 m, the third mirror of the loop being a flat mirror positioned between the other mirrors e.g. to “fold” the delay line (e.g. as illustrated in FIGS. 4A-B).

FIG. 9 is a plot of simulated output pulse intensity with time, according to some embodiments of the disclosure.

Where, exemplary parameters inputted to produce simulation results include: A cascader including 22 loops, each loop having a splitter and three mirrors. Where the input pulse has a FWHM (full width half medium) of 7 nSec, a loop delay is 26.6 nSec, each mirror of each loop has a reflectance R of 98%. Splitters of each loop have different transmittance T (with transmittance increasing with sequential position along the cascader) and absorbance (Abs) of 1%, the cascader total throughput (e.g. proportion of light intensity/power received being outputted) being 72%.

### Exemplary Overlap

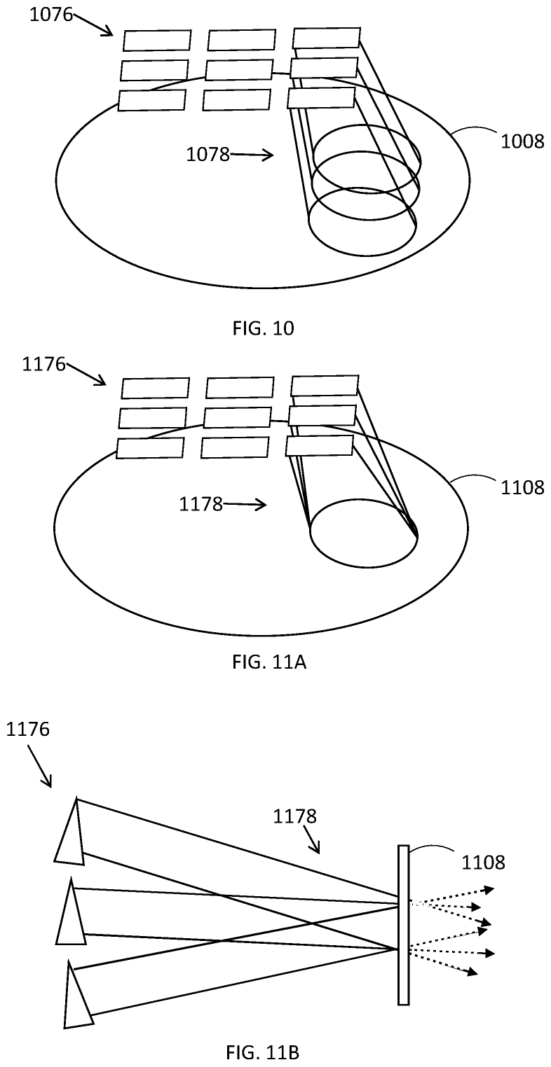

FIG. 10 is a simplified schematic of a splitter array 1076, according to some embodiments of the disclosure.

FIG. 11A is a simplified schematic of a splitter array 1176, according to some embodiments of the disclosure.

FIG. 11B is a simplified schematic cross sectional view of a splitter array 1176, according to some embodiments of the disclosure.

In some embodiments, FIG. 11B illustrates a cross sectional view of the splitter array of FIG. 11A.

FIG. 10, FIG. 11A, and FIG. 11B, in some embodiments, illustrate direction of outputted light from splitter arrays 1076, 1176 respectively. Where, in some embodiments, splitter arrays 1076, 1176 correspond to a system including a plurality of loops (e.g. as described and/or illustrated elsewhere in this document) where, for example, each splitter of spitter arrays 1076, 1176 corresponds to a loop.

Although, in some embodiments, beams are outputted at different times, optionally, in some embodiments, the beams spatially overlap e.g. illuminating sequentially a same portion of the target. Alternatively, in some embodiments, outputted light beams do not spatially overlap.

Referring to both FIG. 10 and FIGS. 11A-B, in some embodiments, splitter/s of splitter arrays 1076, 1176 direct outputted light beams 1078, 1178.

FIG. 10 and FIG. 11A illustrate, in some embodiments, exemplary overlap of outputted light from different loops of exemplary cascaders.

Where, in some embodiments, an extent of overlap is associated with a distance and/or orientation of the target with respect to the cascade and/or to light paths of beams outputted (e.g. a light path extending from where the light is outputted in a direction of emission). Where, for light beams directed in converging directions, for a range of distances of the target from the cascade, at least partial overlapping occurs.

In FIG. 10 and FIG. 11A element 1008, 1108 is positioned at a distance from the splitter arrays for spatial overlap of beams to occur. Where, in some embodiments, element 1008, 1108 includes a substrate to be inspected.

In some embodiments, two or more light pulses 1078, 1178 outputted from splitter array 1076, 1176 are directed (e.g. by the splitters of the splitter array 1076, 1176) to overlap at a target surface 1008, 1108, for example, providing pulsed illumination of a same region of target 1008, 1108.

Where, in some embodiments, e.g. as illustrated in FIG. 10, outputted light beams 1078 partially overlap.

Where, in some embodiments, e.g. as illustrated in FIGS. 11A-B, outputted light beams 1179 fully (e.g. at least by 95%) overlap.

Referring to FIGS. 11A-B, in some embodiments, the same region is a common plane (e.g. on target 1108). Where, in some embodiments, for example, where the beam cross section is a rectangle of 6×3 mm.

FIGS. 12A-B are simplified schematic cross sectional views of a pulse cascader 1204, according to some embodiments of the disclosure.

In some embodiments, FIG. 12A and FIG. 12B illustrate different portions of an optical path through a same pulse cascader 1204.

In some embodiments, pulse cascader 1204 includes a plurality of optical loops, where the loops share at least one optical element 1244.

Where each loop, in some embodiments, includes a splitter 1210, 1212 which splits received light into a first portion 1228, 1232 respectively which is outputted from cascader 1208 and a second portion which is delayed. FIGS. 12A-B illustrate light passage through a single delay line which includes a curved mirror 1244 and a second mirror 1262. Where the light is incident on curved mirror 1244 more than one time, curved mirror, for example, replacing mirrors 444 of delay line 446 FIG. 4A and/or replacing mirrors 444b of delay line 446b FIG. 4B.

### General

As used within this document, the term “about” refers to ±20%.

The terms “comprises”, “comprising”, “includes”, “including”, “having” and their conjugates mean “including but not limited to”.

The term “consisting of” means “including and limited to”.

As used herein, singular forms, for example, “a”, “an” and “the” include plural references unless the context clearly dictates otherwise.

Within this application, various quantifications and/or expressions may include use of ranges. Range format should not be construed as an inflexible limitation on the scope of the present disclosure. Accordingly, descriptions including ranges should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within the stated range and/or subrange, for example, 1, 2, 3, 4, 5, and 6. Whenever a numerical range is indicated within this document, it is meant to include any cited numeral (fractional or integral) within the indicated range.

It is appreciated that certain features which are (e.g., for clarity) described in the context of separate embodiments, may also be provided in combination in a single embodiment. Where various features of the present disclosure, which are (e.g., for brevity) described in a context of a single embodiment, may also be provided separately or in any suitable sub-combination or may be suitable for use with any other described embodiment. Features described in the context of various embodiments are not to be considered essential features of those embodiments, unless the embodiment is inoperative without those elements.

Although the present disclosure has been described in conjunction with specific embodiments thereof, it is evident that many alternatives, modifications, and variations will be apparent to those skilled in the art. Accordingly, this application intends to embrace all such alternatives, modifications and variations that fall within the spirit and broad scope of the appended claims.

All references (e.g., publications, patents, patent applications) mentioned in this specification are herein incorporated in their entirety by reference into the specification, e.g., as if each individual publication, patent, or patent application was individually indicated to be incorporated herein by reference. Citation or identification of any reference in this application should not be construed as an admission that such reference is available as prior art to the present disclosure. In addition, any priority document(s) and/or documents related to this application (e.g., co-filed) are hereby incorporated herein by reference in its/their entirety.

Where section headings are used in this document, they should not be interpreted as necessarily limiting.

1. An illumination module of a wafer inspection system comprising:
an illumination source providing ultraviolet illumination with wavelengths below 300 nm;
a pulse cascader, optically coupled to said illumination source to receive said ultraviolet illumination, which pulse cascade comprising a chain of a plurality of loops, each loop comprising:
a loop input and a loop output, a first loop output optically coupled to a loop input of a subsequent loop in said chain; and a delay line having:
a delay line input optically coupled to said loop input; and
a delay line output, the delay line configured to output a delay line light output, from said delay line output, comprising an image of light received at said delay line input, after a time delay from a time of receipt of light received at said delay line input; and
a splitter configured to receive light at a splitter input and output a first portion of said light from said loop through a loop output and to pass a second portion of said light to said delay line input.

2. The illumination module according to claim 1, wherein said delay line light output has a same divergence as said light received at said delay line input.

3. The illumination module according to claim 1, wherein said delay line light output has a same beam area as said light received at said delay line input.

4. The illumination module according to claim 1, wherein a magnification of said delay line is one.

5. The illumination module according to claim 1, wherein said delay line includes at least one optical element defining a delay line light path light through said delay line;
wherein said time delay is a time taken for light to traverse said delay line light path through said delay line.

6. The illumination module according to claim 5, wherein said delay line light path comprises conjugate focal planes located at said delay line input and said delay line output.

7. The illumination module according to claim 6, wherein said loop output is separated from said loop input by a distance.

8. The illumination module according to claim 1, wherein said splitter and said delay line are configured to orient an optical path of light exiting said loop output in a different direction to said light received by said splitter.

9. The illumination module according to claim 6, wherein splitters and delay lines associated with each loop of said plurality of loops are configured to orient path of light exiting the associated loop in different directions.

10. The illumination module according to claim 1, wherein said delay line comprises a first curved mirror surface and a second curved mirror surface, light traversing an optical path through said delay line being reflected by said first curved mirror surface and then said second curved mirror surface, where said first and said second curved mirror surfaces are positioned and orientated to transfer said image of light received by said delay line input to said delay line output.

11. The illumination module according to claim 10, comprising a third mirror surface where light traversing said optical path is reflected by said third mirror between reflections at said first and said second curved mirror surfaces.

12. The illumination module according to claim 11, wherein said third mirror surface changes a direction of said optical path by at least 90 degrees, folding said optical path.

13. The illumination module according to claim 12, wherein said third mirror surface is a planar mirror surface.

14. The illumination module according to claim 10, wherein one or both of said curved mirror surfaces are spherical mirrors.

15. The illumination module according to claim 1, wherein a plurality of splitters each associated with a loop of said plurality of loops comprise at least two of splitters configured to direct light outputted from said cascader to an overlapping region of space.

16. The illumination module according to claim 1, comprising a pulsed laser light source optically coupled to said splitter input; and wherein a time taken for light to traverse said delay line is longer than a pulse duration of said light source.

17. The illumination module according to claim 1, wherein splitters each associated with a loop of said plurality of loops have different transmissions.

18. An illumination module of a wafer inspection system comprising:
a pulse cascader comprising at least one loop comprising:
a delay line having a delay line input optically coupled to a loop input and a delay line output, which delay line is configured to output a delay line light output, from said delay line output, comprising an image of light received at said delay line input, after a time delay from a time of receipt of light received at said delay line input; and
a splitter configured to receive light at a splitter input and output a first portion of said light from said loop through a loop output and to pass a second portion of said light to said delay line input.

19. A method of optical inspection comprising:
receiving a laser light pulse having a beam area and a divergence;
splitting said laser light pulse into a first light portion and a second light portion;
outputting said first light portion;
delaying said second light portion which second light portion has a same beam area and divergence as said received laser light pulse; and
repeating said splitting with said second light portion, at least once.

20. The method according to claim 19, wherein delaying comprises changing a direction of said second portion from a direction of said received laser light pulse.
